(19) United States
(12) Patent Application Publication
(10) Pub. No.: US 2005/0234733 A1
(43) Pub. Date: Oct. 20, 2005

(54) System and method for company valuation

(76) Inventor: Peter J. Leitner, Pittstown, NJ (US)

Correspondence Address: John M. Johnson;Carter Ledyard & Milburn LLP, 2 Wall Street, New York, NY, 10005, US

(21) Appl. No.: 10/824,256

(22) Filed: Apr. 14, 2004

(51) Int. Cl. G06F 17/60

(52) U.S. Cl. 705/1

(57) ABSTRACT

A system and method for substantially real time company valuation by a plurality of analysts comprising providing company information to the plurality of analysts; receiving an initial company valuation from each of the plurality of analysts; deriving a preferred company valuation based on the initial company valuation from each of the plurality of analysts; providing the initial company valuation from each of the plurality of analysts to all of the plurality of analysts; establishing substantially real time communication between the plurality of analysts for analysis by the plurality of analysts of each of the initial company valuations; receiving a revised company valuation from each of the plurality of analysts based on the substantially real time communication between the plurality of analysts; revising the preferred company valuation based on the revised company valuations from the plurality of analysts to obtain a final company valuation; and compensating the plurality of analysts based on at least one of the proximity of initial company valuation to preferred company valuation and the proximity of revised company valuation to final company valuation.

### BACKGROUND OF THE INVENTION

The stockholders, directors and managers of a closely held firm traditionally rely on a valuation expert to estimate their firm's value. The expert could be an appraiser, an investment banker or a financial advisor, and increasingly could be the corporate development staff within the firm itself. Analyses of corporate value often precede a change in capital structure, such as issuing equity securities in exchange for funding; a change in ownership, such as the purchase or sale of the firm; and matters of financial reporting, taxation and litigation.

Valuation opinions are available from innumerable providers, ranging from independent practitioners to much larger organizations like investment banks, accounting and management consulting firms, which provide valuation advice as a precursor or supplement to their principal services. It is difficult, if not impossible, to quantify the number of people or even firms who will provide a valuation opinion (especially since the basic concepts of valuation are taught to every MBA student), but it is estimated that the U.S. market is between $1 Billion and $2 Billion and is highly fragmented.

Regardless of the industry's size and structure, all agree that firm owners, directors and managers are the Buyers of valuation opinions, while appraisers, investment bankers and financial advisors are the Sellers.

The traditional valuation process, while established and promoted by trade and professional organizations, is static, biased, and at times rife with conflicted interests. At its worst, the process yields an opinion that merely supports a pre-ordained value that the Buyer had in mind or it can be skewed to support activities that are more lucrative for the Seller, such as brokering the transaction that the valuation is supposed to support. In most cases, the Seller's intentions are pure but his opinion is based on highly subjective variables, assumptions and conclusions that are never exposed to competitive market forces that, in the long run, maximize quality and minimize cost to the Buyers.

Given these weaknesses, some Buyers hire multiple Sellers and then average their results, but the Sellers rarely interact in a formal, organized manner so their opinions are still derived as if in darkened silos. And in the instances when they do interact, their final valuation opinions can be remarkably identical, suggesting a covertly coordinated outcome that is designed to reinforce their credibility and justify their fees. In either case, the Buyer of multiple opinions pays for each additional data point.

A need thus exists for an interactive, substantially real time company valuation process among a plurality of analysts whose company valuation opinion is modified based on their interaction.

### SUMMARY OF THE INVENTION

The subject invention is a novel process for making a market in valuation opinions for private companies as well as closely held and illiquid public companies. This occurs by transforming the valuation opinion into an asset for which competitive bids are submitted by valuation experts. The Buyer (also referred to as “Client” herein) of an opinion pays only one fee to Market Maker, who oversees the entire process and ensures orderly market operations, which include:
Origination (marketing to, and contracting with, potential Buyers)
Pre-Pricing (analysis of information that leads to initial valuation opinions)
Primary Pricing (competitive bidding for the most accurate valuation opinion)
Secondary Pricing (option purchases on the outcome of the Primary Pricing)
Settlement (collection of fee from Buyer, distribution of payments to Sellers and option buyers, and delivery of final valuation opinion to the Buyer).

Under the subject invention, the Buyer, Sellers and Market Maker (the “Participants”) communicate simultaneously and in real time. This means:
1. Each Participant can study each initial valuation opinion;
2. Each Participant can communicate with the others by voice in real time;
3. The Sellers can submit one or more revised valuation opinions to the Market Maker (visible only to the Market Maker, Client and submitting Seller);
4. The Sellers and other qualified valuation experts, who have studied each initial opinion, can purchase an option from the Market Maker on the outcome of the competitive bidding).

This could occur face-to-face, but for efficiency a secure Web and telephony communications platform (or something comparable) can be used.

For example, one can employ email to transmit the initial valuation opinions to the Participants; an XML file, which contains the initial bids and grants access to a website to approved Participants, to facilitate the submission of revised valuation opinions; and conference call technology to provide real-time voice communication.

It is emphasized that the above mentioned technology. (email, XML-web, and conference calls) merely facilitates the innovation in an inexpensive and efficient manner. The same results can be achieved without any of these tools, or by implementing different tools performing like functions.

Through the subject invention the following benefits are derived:
1. The Buyer receives multiple valuation opinions for the price of one. This includes:
   a. Two or more initial valuation opinions;
   b. Numerous revised valuation opinions; and
   c. A limited number of option positions, which convey expert opinions about the validity of the mean initial value.
2. The opinions are derived through a highly competitive and transparent process the Buyer can observe directly;
3. The Sellers are guaranteed reasonable minimum compensation for providing their expertise;
4. The Sellers have significant economic incentive to provide a thoroughly prepared initial valuation opinion;
5. The Sellers have a significant economic incentive to consider their peer's analyses and then either persuade them to change their opinions or to change their own;
6. The Sellers and their opinions are economically immune to conflicts of interest and undue influence by the Buyers; and
7. A database of valuation opinions will result that provides benchmarks for a later analysis of the Buyer's firm or of other comparable companies.

The subject invention fundamentally improves the manner in which private and closely-held firms and their strategic assets are valued by experts. These improvements offer significant benefits to those who buy valuation opinions, and indeed to those individuals who are truly qualified and expert in providing them.

The present invention contemplates a system and method for substantially real time company valuation by a plurality of analysts comprising providing company information to the plurality of analysts; receiving an initial company valuation from each of the plurality of analysts; deriving a preferred company valuation based on the initial company valuation from each of the plurality of analysts; providing the initial company valuation from each of the plurality of analysts to all of the plurality of analysts; establishing substantially real time communication between the plurality of analysts for analysis by the plurality of analysts of each of the initial company valuations; receiving a revised company valuation from each of the plurality of analysts based on the substantially real time communication between the plurality of analysts; revising the preferred company valuation based on the revised company valuations from the plurality of analysts to obtain a final company valuation; and compensating the plurality of analysts based on at least one of the proximity of initial company valuation to preferred company valuation and the proximity of revised company valuation to final company valuation.

Preferably, in the system and method a market maker is present during the substantially real time communication and a specific one of the revised company valuations is communicated to the market maker and to the one of the plurality of analysts who provided the specific one of the company valuations and is not communicated to the plurality of analysts who did not provide the specific one of the revised market valuations whereby the market maker is communicated all of the revised company valuations.

Preferably, the system and method further comprises providing the preferred company valuation to each of the plurality of analysts prior to establishing the real time communication between the plurality of analysts; receiving from the plurality of analysts hedge options based on the initial company valuation of the plurality of analysts. The hedge options are at least one of rich options, lean options and fair options.

Preferably, the system and method further comprises providing the preferred company valuation to a third party prior to establishing the substantially real time communication between the plurality of analysts; providing all of the initial company valuation by the plurality of analysts to the third party prior to establishing the substantially real time communication between the plurality of analysts; and receiving from the third party options based on the initial company valuations of the plurality of analysts.

### BRIEF DESCRIPTION OF THE DRAWINGS

The above and other objects and advantages of the present invention will become more readily apparent upon consideration of the following detailed description, taken in conjunction with the accompanying drawings, in which like reference characters refer to like parts throughout the drawings in which:

FIG. 1 is an exemplary computer screen shot of the log in screen of the subject invention;

FIG. 2 is an exemplary computer screen shot of the initial Price screen before Primary Pricing for Primary Analyst 1 of the subject invention;

FIG. 3 is an exemplary computer screen shot of the initial Price screen before Primary Pricing for Primary Analyst 2 of the subject invention;

FIG. 4 is an exemplary computer screen shot of the initial Price screen before Primary Pricing for Primary Analyst 3 of the subject invention;

FIG. 5 is an exemplary computer screen shot of the initial Price screen before Primary Pricing for the Client;

FIG. 6 is an exemplary computer screen shot of the initial Price screen before Primary Pricing for the Market Maker;

FIG. 7 is an exemplary computer screen shot of an active Price screen during Primary Pricing for Primary Analyst 1 of the subject invention;

FIG. 8 is an exemplary computer screen shot of an active Price screen during Primary Pricing for Primary Analyst 2 of the subject invention;

FIG. 9 is an exemplary computer screen shot of an active Price screen during Primary Pricing for Primary Analyst 3 of the subject invention;

FIG. 10 is an exemplary computer screen shot of an active Price screen during Primary Pricing for the Client; and

FIG. 11 is an exemplary computer screen shot of an active Price screen during Primary Pricing for the Market Maker.

### DETAILED DESCRIPTION OF THE PREFERRED EMBODIMENTS

The present invention contemplates a system and method for substantially real time company valuation by a plurality of analysts comprising providing company information to the plurality of analysts; receiving an initial company valuation from each of the plurality of analysts; deriving a preferred company valuation based on the initial company valuation from each of the plurality of analysts; providing the initial company valuation from each of the plurality of analysts to all of the plurality of analysts; establishing substantially real time communication between the plurality of analysts for analysis by the plurality of analysts of each of the initial company valuations; receiving a revised company valuation from each of the plurality of analysts based on the substantially real time communication between the plurality of analysts; revising the preferred company valuation based on the revised company valuations from the plurality of analysts to obtain a final company valuation; and compensating the plurality of analysts based on at least one of the proximity of initial company valuation to preferred company valuation and the proximity of revised company valuation to final company valuation.

Primary Pricing

The Market Maker (i.e. the individual or entity in control of the establishment and functionality of the system and method of the present invention) determines the number of Primary Analysts (those who engage in analysis, bid submission and Primary Pricing, in contrast to Secondary Analysts) and the dollar value of the Bidding Pool (pre-set for each Primary Pricing, thereby informing each Primary Analyst what the minimum and maximum compensation will be) based on the size and complexity of the client asset(s) to be analyzed. Two or more (defined herein as a “plurality”) Primary Analysts are selected to participate, and each receives and analyzes a confidential memorandum prepared by the Market Maker. The confidential memorandum can be based on information received from the company to be valued. The information received from the company to be valued can be obtained based on answers by the company to queries provided by non-limiting example in Table 1 entitled Request for Information:

TABLE 1
Request for Information

An integral step in preparing a complete proposal for management or
advisory services is the review and evaluation of certain information
pertaining to your firm.
I. FINANCIAL and TAX INFORMATION

| A. | Annual financial statements, consolidated and by subsidiary or | |
|---|---|---|
| | division, from the past five years. Please include: | |
| | 1. | Income statement |
| | 2. | Statement of financial position (balance sheet) |
| | 3. | Statement of changes in cash flow |
| | 4. | Statement of retained earnings |
| | 5. | Accompanying notes to financial statements |
| B. | Most recent interim financial statements, i.e., monthly and | |
| | quarterly, and comparative financial statements from prior year; | |
| C. | Most recent annual federal tax return; | |
| D. | Most recent management information letter and recommendations | |
| | from auditor; | |
| E. | Annual budgets for the past two years, current year, and next | |
| | fiscal year. | |
| F. | If a new venture for which none of the above information exists, | |
| | then please substitute with the following: | |
| | 1. | List of cash and in-kind resources contributed thus far |
| | | and by whom |
| | 2. | List of uses of said cash and in-kind resources |
| | 3. | List of intellectual property including patents, trademarks, |
| | | copyrights (or applications thereof). |
| | 4. | If venture is expected to substantially rely on trade |
| | | secrets, please so indicate. |

| | |
|---|---|
| G. | Information regarding any past or pending lawsuits; securities, |
| | trade or criminal complaints; non-trade liens; endorsements or |
| | guarantees. |

II. CORPORATE GOVERNANCE AND STOCKHOLDER INFORMATION

| A. | Articles of incorporation, including all amendments; | |
|---|---|---|
| B. | By-laws, including all amendments; | |
| C. | All shareholder agreements, voting agreements and voting trusts, | |
| | and liquidity (i.e., “buy-sell”) agreements; | |
| D. | Of the directors (and shareholders, if privately held): | |
| | 1. | Name |
| | 2. | Mailing address, email address, business telephone |
| | 3. | Number and type of shares owned or controlled |

| | |
|---|---|
| E. | Information regarding any contingent claims by owners of equity |
| | or debt securities issued by the company. |

III. OTHER INFORMATION

| | |
|---|---|
| A. | Resumes of officers, directors, and key employees of the company; |
| B. | Current business plan; |
| C. | Master list of all products (or services); |
| D. | Master list of all vendors; |
| E. | Product (or services) catalogue and price list. |

Each Analyst prepares an independent valuation analysis (the “Initial Bid” or “initial company valuation”) based on (1) the confidential memorandum, (2) discussions with the Market Maker and/or the client, and (3) other exogenous information he or she decides to use and cite. Exogenous information includes, by non-limiting example: comparable public company financial information (www.sec.gov), comparable public company stock price information (any web source of prices, such Yahoo! or financial websites with recent prices), information from prior transactions of comparable public companies (www.sec.gov), information from prior transaction of comparable private companies (commercial databases, such as www.bvresources.com), industry reports and data from public (US, state governments) and private (e.g., Forrester, Gartner Group, Frost & Sullivan, plus investment bank research) sources, business, finance and trade periodicals, and industry and functional (i.e., valuation, finance, accounting) knowledge and expertise of each analyst. Each Analyst submits his/her Bid, in Microsoft Word, PowerPoint and/or Excel, to the Market Maker, who reviews it for completeness, accuracy and appropriateness. A non-limiting Initial Bid example is shown in Table 2 and Table 3:

TABLE 2

| Code Name: | Project Epsilon | |
|---|---|---|
| Client: | Hotshot Biomedical, Inc. Boston, MA | |
| Purpose: | Pre-money valuation before strategic investment by | |
| | undisclosed firm | |
| Methodology: | Comparable Company Approach, adjusted for: | |
| | Liquidity (75%), Minority Interest (33%), Enterprise | |
| | Risk (50% PVIF) | |
| | Industry composite of specialty pharma (80% and medical | |
| | devices (20%) | |
| | Revenue forecast - Hotshot Biomedical management Net | |
| | income forecast - Hotshot Biomedical management Comparable | |
| | Company financials -- SEC¹ | |
| | Company Company share prices -- Yahoo² | |
| Valuation: | US$10,000,000 (see attached Excel spreadsheet) | |
| Rationale: | Valuation supported by: | |
| | 1. | Proof-of-concept, IP license income from two |
| | | established strategic players |
| | 2. | All IP complete |
| | 3. | Technology positioned to take share AND expand |
| | | the market |
| | 4. | Technology is platform for follow-on applications |
| | 5. | Credible management team |
| Valuation Risks: | Principal risks to be considered: | |
| | 1. | Revenue forecast (by management) is untested and |
| | | optimistic |
| | 2. | Capital requirement (by management) may be |
| | | inadequate, thereby prompting equity default and |
| | | loss of control to proposed partner. |

¹www.sec.gov
²www.yahoo.com

TABLE 3
HOTSHOT BIOMEDICAL, INC. COMPARABLE COMPANY VALUATION ANALYSIS

| Comparable Companies | | | | | | | | | | |
|---|---|---|---|---|---|---|---|---|---|---|
| | | | Price | Financial Information (all in $1,000,000 except per share data) | | | | | | |
| | | | Per | | | Enterprise | | Net | | |
| EV/NI Name | Symbol | | Share | MktCap | Debt | Value | Revenue | Income | EV/Rev | |
| Vivus | WUS | $ 3.65 | $137.62 | $— | $ | $137.62 | $24.85 | $(3.89) | 5.54 | (35.39) |
| Connetics | CNCT | $ 17.98 | 572.09 | 90.00 | | 662.09 | 69.958 | −11.231 | 9.46 | (58.95) |
| Cambrex | CBM | $ 25.40 | 655.14 | 268.00 | | 923.14 | 434.233 | 4.115 | 2.13 | 224.34 |
| Medicis | MRX | $ 71.76 | 1,970.00 | 453.00 | | 2,423.00 | 252.089 | 12.213 | 9.61 | 198.40 |
| Enzon | ENZN | $ 12.27 | 534.00 | 400.00 | | 934.00 | 161.983 | 35.746 | 5.77 | 26.13 |
| Waters | WTRS | $ 6.93 | 16.00 | 3.50 | | 19.50 | 25.14 | 0.70 | 0.78 | 27.94 |
| Instruments | | | | | | | | | | |
| ZEVEX | ZVXI | $ 3.99 | 13.57 | 2.78 | | 16.35 | 26.67 | (0.23) | 0.61 | (72.03) |
| International | | | | | | | | | | |
| Anika | ANIK | $ 8.91 | 88.98 | — | | 88.98 | 14.86 | 0.86 | 5.99 | 104.07 |
| Therapeutics | | | | | | | | | | |
| Cholestec | CLEC | $ 7.57 | 105.86 | 131.80 | | 237.66 | 304.86 | (17.98) | 0.78 | (13.22) |
| Surmodics | SRDX | $ 23.97 | 417.96 | | | 417.96 | 43.23 | 13.94 | 9.67 | 29.99 |
| Arithmetic | | | | $451.12 | $ 134.91 | $586.03 | 135.79 | $3.42 | 5.03 | 43.13 |
| Mean | | | | | | | | | | |
| Composite | | | | | | | | | | |
| Specialty | | | | $773.77 | $ 242.20 | $1,015.97 | 188.62 | $7.39 | 6.50 | 70.90 |
| Pharma | | | | | | | | | | |
| Medical | | | | $128.47 | $ 27.62 | $156.09 | 82.95 | $(0.54) | 3.56 | 15.35 |
| Devices | | | | | | | | | | |

Hotshot Biomedical visa-vis Composite (n = 10)

| | | | | | | |
|---|---|---|---|---|---|---|
| Revenue (Year 5) | $ 57,600,000 | | Net Income (Year 5) | | $ 13,200,000 | |
| Market Multiple | | 5.03 | Market Multiple | | | 43.13 |
| Gross Value | $289,893,290 | | Gross Value | | $ 569,283,162 | |
| Liquidity Discount | | 0.25 | | | | 0.25 |
| Rate | | | | | | |
| | $ 72,473,322 | | | | $ 142,320,791 | |
| | | | | Liquidity | | |
| | | | | Discount Rate | | |
| Minority Discount | | 0.67 | | | | 0.67 |
| Rate | | | | | | |
| | $48,557,126 | | | | $ 95,354,930 | |
| Risk Discount | $(42,162,772) | | Risk Discount | | $(82,797,902) | |
| (PVIF 50%) | | | (PVIF 50%) | | | |
| Valuation | $6,394,354 | | Valuation | | $12,557,028 | |

Hotshot Biomedical vis-9-vis Specialty Pharmaceuticals (n = 5)

| | | | | | | |
|---|---|---|---|---|---|---|
| Revenue (Year 5) | $ 57,600,000 | | Net Income (Year 5) | | $ 13,200,000 | |
| Market Multiple | | 6.50 | Market Multiple | | | 70.90 |
| Gross Value | 374,461,296 | | Gross Value | | $ 935,933,624 | |
| Liquidity Discount | | 0.25 | | Liquidity Discount | | 0.25 |
| Rate | | | | Rate | | |
| | $ 93,615,324 | | | | $ 233,983,406 | |
| Minority Discount | | 0.67 | | Minority Discount | | 0.67 |
| Rate | | | | Rate | | |
| | $ 62,722,267 | | | | $ 156,768,882 | |
| Risk Discount | $ (54,462,545) | | Risk Discount | | $(136,124,420) | |
| (PVIF 50%) | | | (PVIF 50%) | | | |
| Valuation | $8,259,722 | | Valuation | | $20,644,462 | |

Hotshot Biomedical visa-vis Medical Devices (n = 5)

| | | | | | |
|---|---|---|---|---|---|
| Revenue (Year 5) | $ 57,600,000 | | Net Income (Year 5) | $ 13,200,000 | |
| Market Multiple | | 3.56 | Market Multiple | | 15.35 |
| Gross Value | $205,325,283 | | Gross Value | $ 202,632,700 | |
| Liquidity Discount Rate | | 0.25 | | | 0.25 |
| | $ 51,331,321 | | | $ 50,658,175 | |
| | | | Liquidity Discount Rate | | |
| Minority Discount Rate | | 0.67 | | | 0.67 |
| | $ 34,391,985 | | | $ 33,940,977 | |
| Risk Discount | $ (29,862,999) | | Risk Discount | $(29,471,383) | |
| (PVIF 50%) | | | (PVIF 50%) | | |
| Valuation | $4,528,986 | | Valuation | $4,469,594 | |

| | |
|---|---|
| Revenue Basis | Net Income Basis |

| | | | | |
|---|---|---|---|---|
| High | $ 8,259,722 | Specialty Phamia | $ 20,644,462 | Specialty Pharma |
| Mid | $ 6,394,354 | Composite | $ 12,557,028 | Composite |
| Low | $ 4,528,986 | Medical Devices | $ 4,469,594 | Medical Devices |
| Arithmetic Mean | $ 6,394,354 | | $ 12,557,028 | |
| 80% | $ 6,607,778 | Specialty Pharma | $ 16,515,570 | Specialty Pharma |
| 20% | $ 905,797 | Medical Devices | $ 893,919 | Medical Devices |
| Weighted Mean | $ 7,513,575 | | $ 17,409,488 | |

Summary Valuation

| | | |
|---|---|---|
| Revenue Basis - Arithmetic | $ | 6,394,354 |
| Revenue Basis - Weighted | $ | 7,513,575 |
| Net Income Basis - Arithmetic | $ 12,557,028 | |
| Net Income Basis - Weighted | $ 17,409,488 | |
| Arithmetic Mean Value | $ 10,988,611 | |
| Median Value | $ 10,035,302 | |

When all Primary Analysts' Bids are accepted, they will be memorialized (e.g., converted to PDF) and then posted for example, on the web site described below, for review by all Primary and Secondary Analysts. During Primary Pricing, each Primary Analysts will present and defend his/her analysis, and critique the others, all the while electronically submitting new Bids to the Market Maker which other Analysts cannot see, until each submits a Final Bid (or “revised company valuation”). At the close of Primary Pricing, Primary Analysts will be compensated from a fixed pool of US Dollars set up by the Market Maker. A Summary of Primary Pricing is shown below in Table 4:

TABLE 4
Primary Pricing

| TASK | RESPONSIBILITY | SUB-TASK | DESCRIPTION |
|---|---|---|---|
| 1. Prepare Numeria | Market | a | Assign ticker symbol to client firm |
| | Maker | b | Start web platform |
| | | c | Populate, test, and load case data file |
| | | d | Log on to moderator screen, confirm set up |
| | | e | Start price history (print sheet) |
| | | f | Log on to client screen, confirm set up |
| | | g | Permit log ons and price changes |
| 2. Sign On | Primary Analysts | a | Log onto web platform |
| | Client | | (www.numeria.waterfordadvisors.com) |
| | Financial Advisor | b | Activate telephony (Conferencecall.com) |
| 3. Introduction | Market | a | Welcome participants |
| | Maker | b | Confirm ticker symbol, purpose of valuation |
| | | c | Roll call of Primary Analysts |
| | | d | Confirm mean initial value |
| | | e | Announce Put/Call ratio (from Secondary Analysts) |
| | | f | Announce order of operations |
| 4. Pricing | Primary Analysts | a | Present and defend analyses |
| | | b | Submit email requests to Market Maker for client question(s) |
| | | c | If granted by Market Maker, pose question(s) to clients |
| | | d | Submit new prices at will |
| 5. Closing | Market Maker | a | Call for final prices |
| | | b | Deny price changes |
| | | c | Announce mean final price |
| | | d | Announce final prices by analyst |
| | | e | Thank participants |
| | | f | Deny log ons |
| | | g | Stop web platform |
| 6. Settlement | Market Maker | a | Confirm initial and final prices by each Primary Analyst |
| | | b | Confirm mean initial and mean final prices |
| | | c | Allocate Primary Analyst Pool |
| | | d | Process payments |

Allocation of Compensation vis-à-vis Bids

Before Primary Pricing starts, the Initial Bids (“initial company valuations”) are averaged (arithmetic mean) to determine the Initial Mean Value (IMV) (or “preferred company valuation”), and 50% of the Bidding Pool is awarded as follows: If there are two Primary Analysts, then the Initial Bid closest to the IMV receives 80% and the other receives 20%. If there are three Primary Analysts, then the Initial Bid closest to the IMV receives 60%; the Bid next closest to the IMV receives 30%; and the Bid furthest from the IMV receives 10%. If there are five Primary Analysts, then the Initial Bid closest to the IMV receives 50%; the Initial Bid furthest from the IMV receives 10%; and the other three each receive 13%. Therefore, before Pricing begins the Primary Analysts will know their compensation for their Initial Bids. With 50% of the Bidding Pool on the line, there is incentive to deliver the best Initial Bid possible.

During the Primary Pricing phase, the objective turns to assimilating new information (from the other Initial Bids and debate among the Analysts) into follow-on bids. It is expected that Analysts will challenge the analyses of others' while defending their own. With new information, Analysts may electronically submit new Bids at will until the Market Maker calls for Final Bids (or “revised company valuations”) and closes the market. Only the Market Maker and the Client can see all of the new Bids as they are submitted, as well as their effect on the Average Bid (the arithmetic mean of all most recent Bids); Analysts only know their own bids.

When Pricing ends, the Market Maker will declare the Final Mean Value (FMV) (or “final company valuation”) as well as the proximity of each Analyst's Final Bid to the FMV. The remaining 50% of the Bidding Pool will be allocated using the same calculus as with the IMV. A summary of an exemplary Analyst allocation of compensation matrix is shown below in Table 5:

TABLE 5

| | | Share of Pool | | | | | |
|---|---|---|---|---|---|---|---|
| | Analysts | High | Mid | Mid | Mid | Low | Totals |
| START UP | | | | | | | |
| Concept | 1 | $ 1,250 | | | | | |
| Formation | 2 | $ 1,250 | | | | $ 1,250 | |
| EMERGING | | 80% | | | | 20% | |
| Proof of | 2 | $ 5,000 | | | | $ 1,250 | $ 6,250 |
| Concept | | | | | | | |
| | | 60% | | 30% | | 10% | |
| Development | 3 | $ 7,500 | | $ 3,750 | | $ 1,250 | $ 12,500 |
| Market | 3 | $ 7,500 | | $ 3,750 | | $ 1,250 | $ 12,500 |
| Introduction | | | | | | | |
| GROWTH | | 50% | 13% | 13% | 13% | 10% | |
| Early Revenue | 5 | $ 8,750 | $ 2,333 | $ 2,333 | $ 2,333 | $ 1,750 | $ 17,499 |
| Recurring | 5 | $ 8,750 | $ 2,333 | $ 2,333 | $ 2,333 | $ 1,750 | $ 17,499 |
| Revenue | | | | | | | |
| Accelerating | 5 | $ 8,750 | $ 2,333 | $ 2,333 | $ 2,333 | $ 1,750 | $ 17,499 |
| Revenue | | | | | | | |
| MATURE | | 50% | 13% | 13% | 13% | 10% | |
| Slowing | 5 | $ 8,750 | $ 2,333 | $ 2,333 | $ 2,333 | $ 1,750 | $ 17,499 |
| Growth | | | | | | | |
| Steady | 5 | $ 8,750 | $ 2,333 | $ 2,333 | $ 2,333 | $ 1,750 | $ 17,499 |
| Revenue | | | | | | | |
| Uneven | 5 | $ 8,750 | $ 2,333 | $ 2,333 | $ 2,333 | $ 1,750 | $ 17,499 |

Secondary Pricing

After Primary Analysts are selected and their Initial Bids are posted, the Market Maker notifies all other analysts under contract, retainer or agreement who are not Primary Analysts in this particular valuation (the “Secondary Analysts”) that Initial Bids for a valuation are available for their review and consideration. If, upon reviewing the Initial Bids and considering the Mean Initial Value (MIV), a Secondary Analyst wants to take a position about its accuracy, he or she may do so by purchasing Rich, Lean or Fair Options from the Market Maker. In addition, Primary Analysts may also purchase options to hedge their Initial Bids. The price of each option will be determined by the Market Maker, as will the number units available of each (based on underwriting considerations).

Rich Options are appropriate if the Analyst believes, after reviewing all of the Initial Bids, that the Mean Final Value (MFV) will be less than the MIV. If, during Primary Pricing, the MFV is indeed more than 5% below the MIV, then the options will be “in the money” and the Analyst will receive a payoff of two times his principal, for example. If they are out of the money, they expire worthless. Lean Options are appropriate if the Analyst believes that the MFV will be higher than the MIV. If it is indeed more than 5% higher than the MIV, then the Analyst will receive a payoff of two times his principal, for example. Otherwise, they expire worthless. Fair Options are appropriate if the Analyst believes that the MIV is fair and the MFV will be no more than 5% above or below the MIV. If so, the Analyst will receive a payoff of five times his principal, for example; if not, they are worthless.

Each Analyst who wants to purchase one or more Rich, Lean or Fair Options must communicate (for example by email) his request to the Market Maker by a prescribed time. The Market Maker will be under no obligation to fill each order, in whole or part, and will do so only within its own underwriting constraints. At the opening of Primary Pricing, the Market Maker will communicate the number of Rich, Lean and Fair option orders that have been placed. Following the completion of Primary Pricing, payments to the Analysts whose options closed in the money will follow normal settlement procedures. A non-limiting example of one possible option-based secondary pricing structure is provided in Table 6 and Table 7:

TABLE 6

| If Analyst thinks MN is: | | Factor | |
|---|---|---|---|
| | If MIV > MFV, then payoff if + | 2 | $ 50.00 |
| Too High, then buy a Rich Option $ 25.00 | | | |
| | If MN < MFV, then payoff is − | | $ — |
| | If MIV > MFV then payoff is − | | $ — |
| Too Low, then buy a Lean Option $ 25.00 | | | |
| | If MIV < MFV, then payoff is + | 2 | $ 50.00 |
| | If MIV > MFV then payoff is − | | $ |
| Fair, then buy a Fair Option $ 25.00 | If MIV < MFV, then payoff is − | | $ |
| | If MIV = MFV, then payoff is + | 5 | $ 125.00 |

| | | Winner | | Rich | | Lean | Fair | Total | |
|---|---|---|---|---|---|---|---|---|---|
| Scenario I: | MIV | Rich | | | 200 | 225 | 10 | | 435 |
| | | | Revenue | $ 5,000.00 | | $ 5,625.00 | $ 250.00 | $ 10,875.00 | |
| | | | Payoff | $10,000.00 | | $ — | $ — | $ 10,000.00 | |
| | | | Net | $ (5,000.00) | | $ 5,625.00 | $ 250.00 | $ | 875.00 |
| Scenario II: | MIV | Lean | | | 200 | 225 | 10 | | 435 |
| | | | Revenue | $ 5,000.00 | | $ 5,625.00 | $ 250.00 | $ 10,875.00 | |
| | | | Payoff | $ — | | $11,250.00 | $ — | $ 11,250.00 | |
| | | | Net | $ 5,000.00 | | $ (5,625.00) | $ 250.00 | $ | (375.00) |
| Scenario III: | MIV | Fair | | | 200 | 225 | 10 | | 435 |
| | | | Revenue | $ 5,000.00 | | $ 5,625.00 | $ 250.00 | $ 10,875.00 | |
| | | | Payoff | $ — | | $ — | $ 1,250.00 | | $ 1,250.00 |
| | | | Net | $ 5,000.00 | | $ 5,625.00 | $ (1,000.00) | | $ 9,625.00 |

* Delta must be > +1 − 5% of MIV

TABLE 7
SECONDARY PRICING

| TASK | RESPONSIBILITYSUB- | | DESCRIPTION |
|---|---|---|---|
| 1 Analyst | Managing | None | By email to Secondary Analysts, |
| Selection | Partner | | present client profile, purpose |
| | | | of valuation, and deliverable |
| | | | schedule |
| 2 Bid | Secondary | None | Critique summary valuation |
| Analysis | Analysts | | analyses by Primary Analysts |
| 3 Submit | Secondary | a | By email, submit Lean options |
| Orders | Analysts | | to Market Maker |
| | | b | By email, submit Rich options |
| | | | to Market Maker |
| | | c | By email, submit Fair options |
| | | | to Market Maker |
| 4 Accept/ | Market | a | Review all orders, first come |
| Decline | Maker | | first served |
| Orders | | b | Allocate put, call and fair |
| | | | price dollars based on Secondary |
| | | | Analyst Pool and lean, rich and |
| | | | fair options |
| | | c | By email, notify Secondary |
| | | | Analysts of Accepted/Declined |
| | | | orders |
| 5 Close - | Market | None | Announce Mean Final Price |
| Primary | Maker | | |
| Pricing | | | |
| 6 Settlement | Market | a | Confirm lean, rich and fair |
| | Maker | | options by each Secondary |
| | | | Analyst |
| | | b | Confirm mean initial and |
| | | | mean final prices |
| | | c | Allocate Secondary |
| | | | Analyst Pool |
| | | d | Process payments |

User Communication Interface

The user communication interface of the present invention utilizes components based on the type and timing of the desired communications. For communications prior to the preferably substantially real time communication between the plurality of Primary Analysts, the Market Maker and optionally the Client wherein Primary Pricing occurs, various modes of communications can be used for each Primary Analysts to receive the confidential memorandum from the Market Maker, for each Primary Analyst to submit his/her Initial Bid to the Market Maker, for these Initial Bids to be communicated to all the Primary Analysts and Secondary Analysts, and for all communications involving Secondary pricing where options are offered by the Primary Analysts and Secondary Analysts to the Market Maker, and these option offers are accepted or rejected by the Market Maker. These above types of communications can be implemented using face-to-face communication, telephonic communication, facsimile, voice-over-I.P., Internet chat and Internet instant messaging, by non-limiting example.

The user communication interface for the substantially real time Primary Pricing session involving the Market Maker, plurality of Primary Analysts and optionally, the Client, preferably, by non-limiting example, is facilitated by a telephonic conference call system well known in the art for verbal communication, as well as a numeric/text communication system preferably implemented by each of the Market Maker, plurality of Primary Analysts and optionally, the Client having, for example, a personal computer with a 2.8 GHz Intel Pentium 4 Processor, Microsoft Windows XP operating system, 20 GB Hard Drive, 256 MB RAM, and dial-up modem, cable modem or DSL modem for Internet connectivity, as well as the services of an ISP (Internet Service Provider) in order to access the website of the Market Maker via the Internet. The website of the Market Maker is Internet domain space well known in the art and is accessible through a “www” Internet address, and is preferably serviced by password access and data encryption also known in the art. The ISP of the Market Maker preferably hosts the website using Microsoft Windows 2000 (2003) Server. The web page platform is preferably Microsoft Internet Information Services.

When the scheduled time (usually set by the Market Maker) for the Primary Pricing communication session arrives, the Market Maker, Primary Analysts and optionally the Client join the telephonic conference call, under the telephone number and pass number established by the Market Maker, and employ their computers to access the Internet website, again, preferably operated and controlled by the Market Maker, using given log-in names and passwords.

The software of the user communication interface accessible through the website of the Market Maker is preferably, by non-limiting example, coded in Visual Basic (VB.net) using application server pages (ASP.net), and the software application, itself, uses Microsoft Visual Studio.net (v1.1).

The amount of information available to different users, i.e., the degree of “transparency” of the financial data, is preferably variable based on the position of the user accessing the website. For example, the Market Maker (or “moderator” in Table 8, below) and the Client (“client in Table 8) have access to all of the financial data present during the Primary Pricing Session. In contrast, the Primary Analysts (“analysts” in Table 8) have access to all Initial Bids of all of the Primary Analysts as well as access to only his/her own revisions (“revised company valuations”) to his/her Initial Bid (“initial company valuation”), i.e., his/her own one or more “revised company valuations” during the Primary Pricing process, and not the one or more “revised company valuations” of any of the other Primary Analysts, based upon which the “final company valuation” is achieved after calculation of all of the Final Bids (i.e., the last “revised company valuation”) from the plurality of Primary Analysts.

The above is preferably facilitated using .xml, a non-proprietary software protocol of describing and storing data known in the art (alternatively, Microsoft Access may be employed). Table 8 shows an example of the .xml coding that provides the above described varied financial data transparency to the Market Maker (“moderator”), Client (“client”) and Primary Analyst (“analysts”): Table 8

TABLE 8

<?xml version=“1.0” encoding=“utf-8” ?>

<root

xmlns=“http://tempuri.org/numeria.xsd”> •

<company companyname=“Acme

Pharma” /> - <participants>

<participant participantname=“Peter Leitner” password=“waterford”

mode=“moderator” startprice=“0.00” currentprice=“0.00” />

<participant participantname=“lantz” password=“LANTZ” mode=“client”

startprice=“0.00” currentprice=“0.00” />

<participant participantname=“johnson” password=“JOHNSON”

mode=“client” startprice=“0.00” currentprice=“0.00” />

<participant participantname=“Ieitner” password=“LEITNER”

mode=“client” startprice=“0.00” currentprice=“0.00” />

<participant participantname=“chien” password=“CHIEN”

mode=“analyst” startprice=“9475000” currentprice=“0.00” />

<participant participantname=“weaver” password=“WEAVER”

mode=“analyst” startprice=“2000000” currentprice=“0.00” />

<participant participantname=“zhao” password=“ZHAO”

mode=“analyst” startprice=“12900000” currentprice=“0.00”
/>

</participants>

<root>

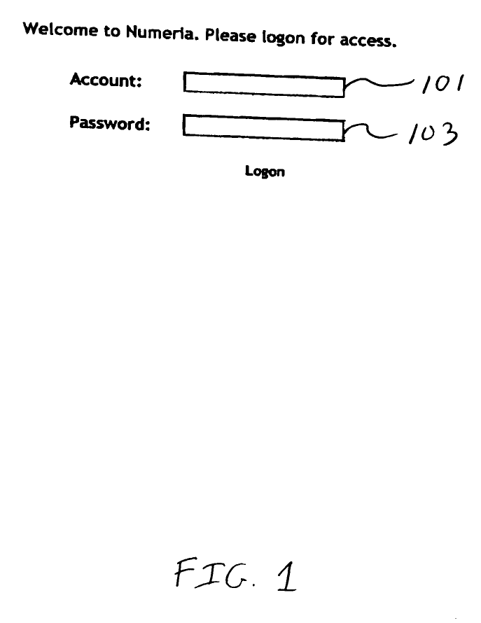

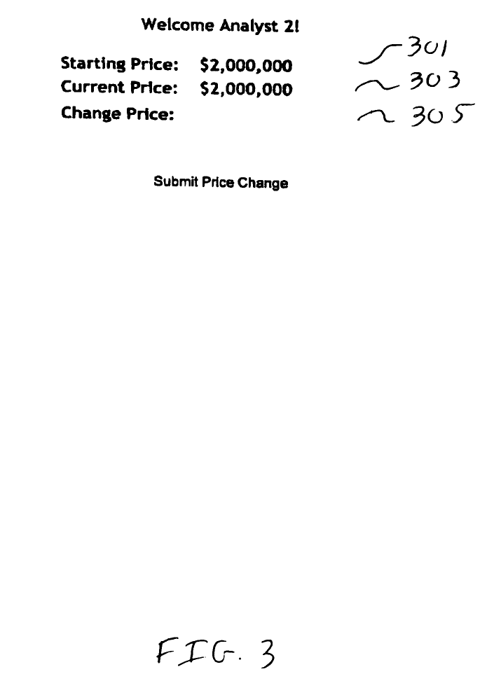

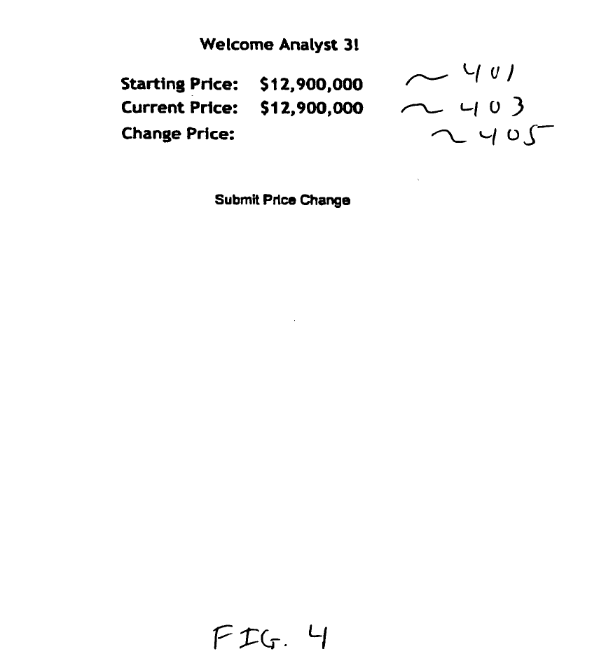

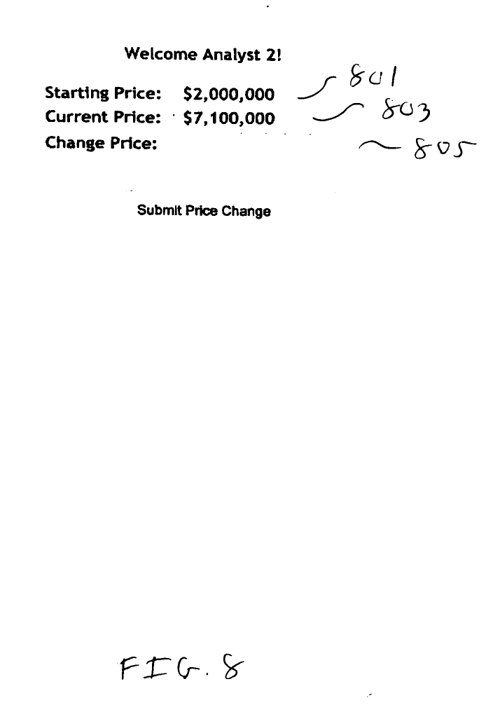

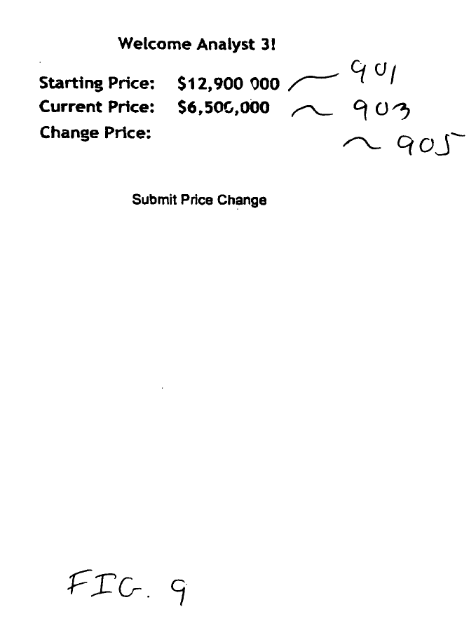

Next referring to FIGS. 1 through 11 website screen shots of a sample Primary Pricing session, from the vantage point of the Market Maker (“moderator”), Primary Analysts 1, 2 and 3 (“analysts”) and Client (“client”) are shown. FIG. 1 shows the log-in screen for all three of the above groups. At 101, the particular user's account name is entered. At 103, the particular user's password is entered. The entry of the account name and password, through the .xml program of Table 8, will attribute the appropriate transparency of financial data and Primary Pricing session website control to that user based on the .xml class to which that user belongs (“moderator”, “client” or “analyst”).

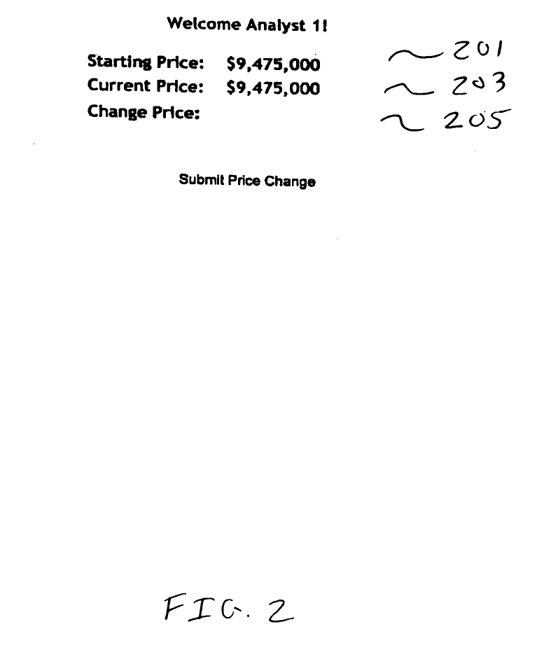

FIGS. 2, 3 and 4 show the initial (prior to session initiation) Price screen for Primary Analysts 1, 2 and 3, respectively, as defined as “analysts” by .xml. Each of FIGS. 2, 3 and 4 show that Analyst's (and only that Analyst's, and no other Analyst's) Starting Price (“initial company valuation”) 201, 301 and 401, respectively; Current Price (“revised company valuation”) 203, 303 and 403, respectively; and Change Price (the option to key-in a change to the Current Price) (i.e. to further revise the “revised company valuation”) 205, 305, 405 respectively. Because no price changes have yet been entered by Primary Analyst 1, 2 or 3, Starting Price 201, 301 and 401, respectively, are the same as Current Price 203, 303 and 403, respectively.

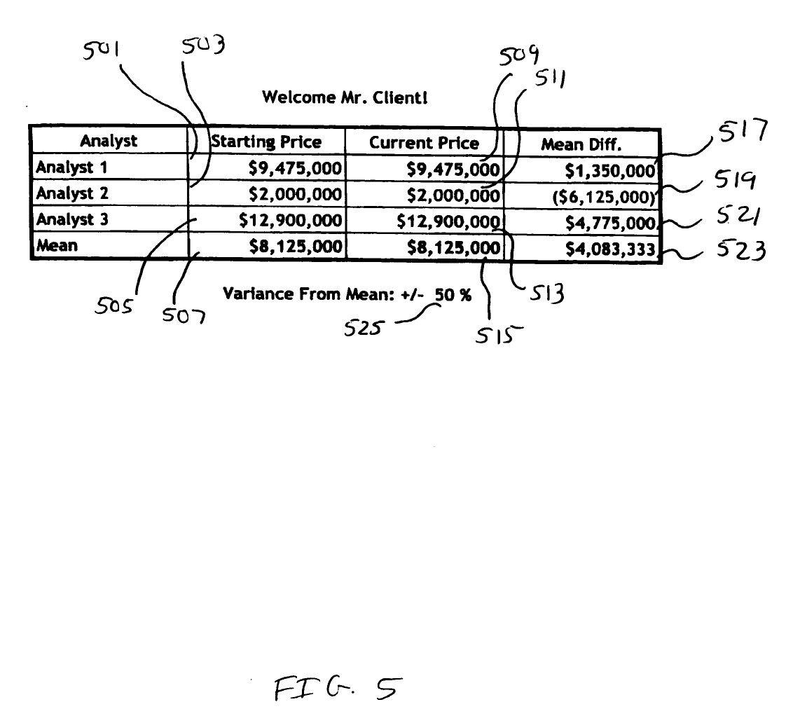

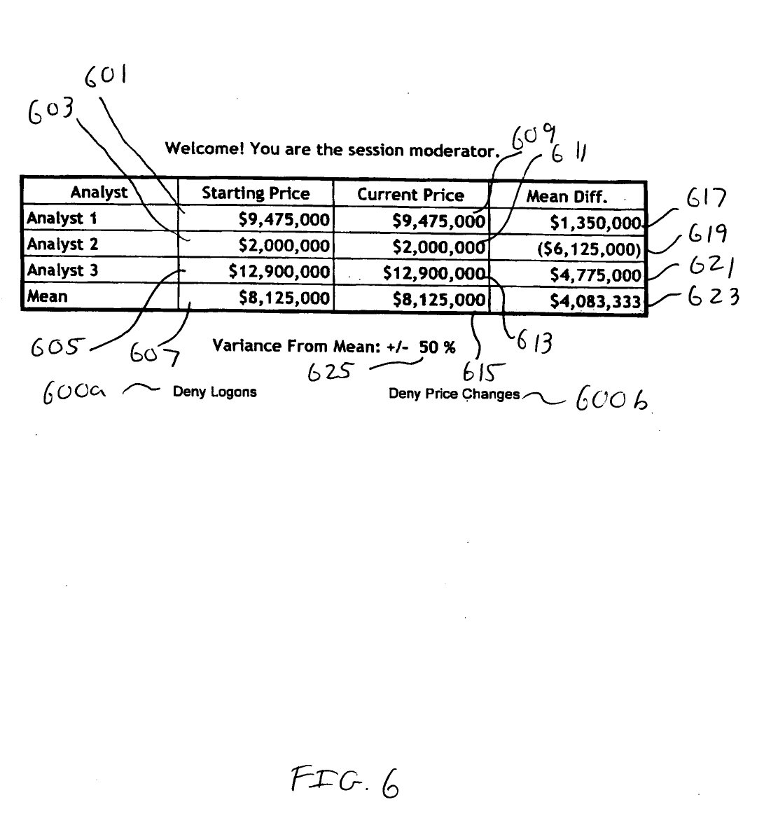

FIGS. 5 and 6 show the initial (prior to session initiation) Price screen for the Client and Market Maker, respectively, as defined as “client” and “moderator”, respectively by .xml. FIGS. 5 and 6 show the same substantive financial data, the difference between the two screens is that, as defined by .xml, the Market Maker (“moderator”) has additional session control functionality for denying logon 600a and denying price changes 600b. FIGS. 5 and 6 show that both the Client and the Market Maker have access to the Starting Price of each Analyst 1, 2 and 3 at 501 and 601, 503 and 603 and 505 and 605, respectively, as well as the Mean thereof at 507 and 607, respectively. Additionally, FIGS. 5 and 6 show the Current Price of each Analyst 1, 2 and 3 (which are the same prior to session initiation as the Starting Price values for each Analyst 1, 2 and 3) 509 and 609, 511 and 611 and 513 and 613, respectively, as well as the Mean thereof at 515 and 615, respectively. FIGS. 5 and 6 also show the Mean Differentials at 517 and 617, 519 and 619, 521 and 621 and 523 and 623, respectively, as well as the variance from Mean at 515 and 625, respectively. As further discussed below, the “final company valuation” is determined and further price changes are denied by the Market Maker employing control 600b where all of the current prices of Primary Analysts 1, 2 and 3 are within a predetermined range of each other, for example +or −5%.

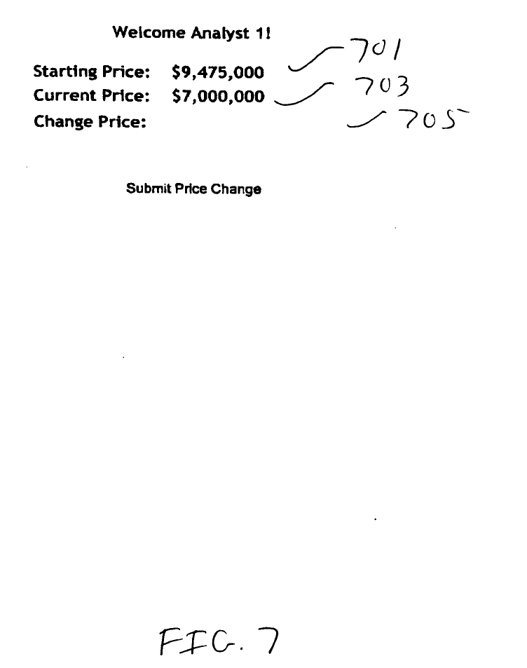

Referring next to FIGS. 7, 8 and 9 active Primary Pricing is shown in which the Price screens for Primary Analysts 1, 2 and 3 have now changed their Starting Prices (“initial company valuations”) 701, 801 and 901, respectively to their Current Price 703, 803, 903, respectively, having used the Change Price option 705, 805 and 905, respectively. The above described Change Price option is implemented after discussion amongst the Primary Analysts 1, 2 and 3 and critique of their various company valuation models and data.

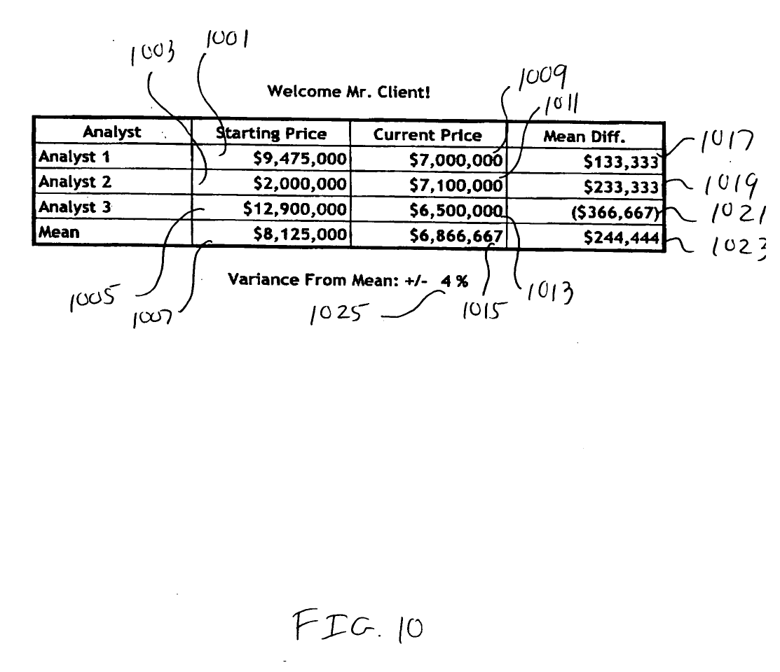

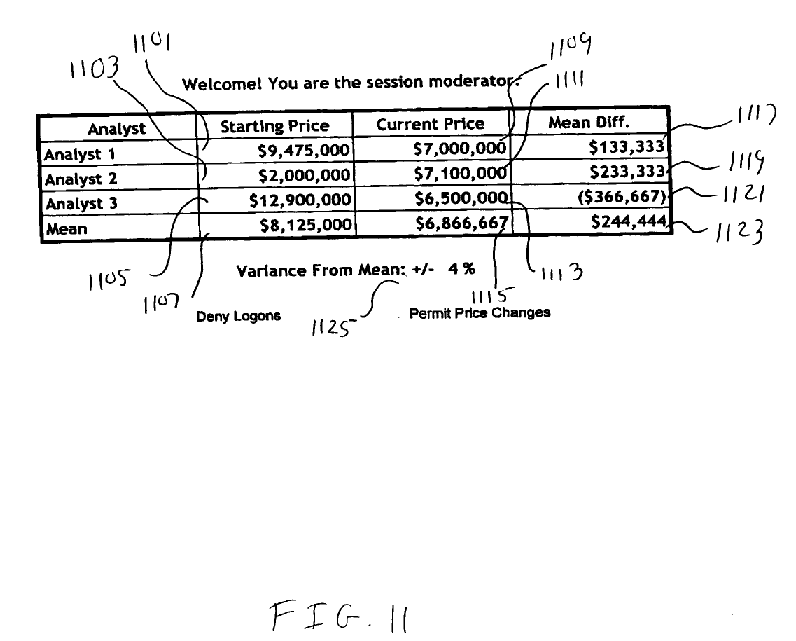

Next referring to FIGS. 10 and 11, the Client and Market Maker, during active Primary Pricing, again have access to the Starting Price values of each Analyst 1, 2 and 3 at 1001 and 1101, 1003 and 1103 and 1005 and 1105, respectively, as well as the Mean thereof at 1007 and 1107, respectively. Note that now, during active Primary Pricing, the Current Prices, 1009 and 1109, 1011 and 1111 and 1013 and 1113, as well as the Mean thereof, 1015 and 1115, are no longer identical to the above Starting Price values as a dialog between Primary Analysts 1, 2 and 3 is occurring. Also shown is the Mean Differentials 1017 and 1117, 1019 and 1119, 1021 and 1121, and 1023 and 1123, respectively as well as the Variance from the Mean at 1025 and 1125, respectively, which has changed from +or −50% to +or −4%. Because the Variance from Mean is now less than +or −5% (+or −4%) the Market Maker employs the “deny price change” function 600b and declares “parity” to the Primary Analysts. Note that more than one round of the Primary Analysts 1, 2 and 3 implementing the Change Price option may occur such that more than one interim “revised company valuation” exists before Final Bids (or last “revised company valuations”) are achieved upon which the “final company valuation” is based, as more than one round may be required to attain a Variance from Mean of +or −5% or less. The “final company valuation” is next calculated based on the Primary Analysts' Final Bids or last “revised company valuations,” as is the proximity of each of the Primary Analysts' Final Bid (or last “revised company valuation”) to the “final company valuation” for Primary Analysts compensation calculation, as discussed above.

An additional preferred aspect of the subject invention pertains to security enhancements of the web site employed for substantially real time communication. The below security features are present in order for clients to know that the confidentiality of the financial information conveyed is maintained.

With the above goals in mind, in the software application of the subject invention, the Market Maker (moderator) has the ability to control any access by the ability to shut down the entire website except for times that a Primary Pricing valuation session is taking place. This is the opposite of the usual website goal of high availability. The goal in the present invention is that the entire site is “invisible” to the public Internet except when the moderator/Market Maker makes it available.

In a second security aspect of the subject invention, whether or not the website is operational, the moderator/Market Maker may wish to insure that no one can access any information about a valuation, including those responsible for the design and maintenance of the software and those at the hosting service who have administrator privileges that would permit them to access the data. The security features of the subject invention allow the moderator/Market Maker to delete the entire xml file from the host site, and the xml file is the only place where any information about a specific valuation is stored. Limiting the “lifespan” of this file on the host site provides significant additional security while allowing easy testing and maintenance through the use of test or dummy xml files as needed.

The above security features can be attained according to the present invention employing, for example, the following method. The normal way that a web page is delivered from the server to the client is by storing a copy of the html page description on the server and passing it, when requested, to the client. This is not the case with the asp.net pages of the subject invention: the server stores parts of each page as static html and computer functions that generate html and control the flow of the pages. This computer code is never delivered to the client web browser; only the results of the code are delivered to the client. In the present invention, when a user enters the account name and password, the entries are compared to the “rows” of the xml file and an exact match must be found. The matching row indicates the “type” of the user (analyst, moderator, etc.) and then a program on the server determines the next screen to load, which will match the type given in the xml data. Application security insures that a user cannot change from one type to another during the valuation.

Thus, in secured operation of the software application of the present invention, the default state of the application is “stopped” which prevents any access from a web browser to the site. The moderator prepares the xml file for a Primary Pricing valuation. This is done on the moderator's local computer. In preparing the xml file, the moderator may enhance security by: using code names for the client company, client accounts and analyst accounts; using hard-to-guess passwords for each; changing the passwords from one Primary Pricing valuation to the next; and not uploading the file to the site until just before the valuation.

When ready, the moderator uploads a copy of the xml file to the site using FTP, a non-proprietary method of moving files on the Internet. Access to the website via FTP is password protected, and without the password one cannot view or change any file on the site. The moderator also uses the control panel feature of the web hosting company to change the status of the site from “stopped” to “started”. This enables browser access to the site. The moderator then invokes an unpublished special page on the site to load the new data from the xml file into the application. The Primary Pricing valuation then takes place.

At the end of the Primary Pricing valuation the moderator uses the control panel feature of the web hosting company to change the status of the site from “started” to “stopped”. No additional web access to the site is permitted until the site is restarted. Finally, the moderator uses FTP to access the files at the site and deletes the entire xml file, which permanently removes all of the data used for the valuation.

It will be apparent to those skilled in the art that a number of changes, modifications, or alterations to the present invention as described herein may be made, none of which depart from the spirit of the present invention. All such changes, modifications, and alterations should therefore be seen as within the scope of the present invention.

1. A method for substantially real time company valuation by a plurality of analysts comprising:
providing company information to the plurality of analysts;
receiving an initial company valuation from each of the plurality of analysts;
deriving a preferred company valuation based on the initial company valuation from each of the plurality of analysts;
providing the initial company valuation from each of the plurality of analysts to all of the plurality of analysts;
establishing substantially real time communication between the plurality of analysts for analysis by the plurality of analysts of each of the initial company valuations;
receiving a revised company valuation from each of the plurality of analysts based on the substantially real time communication between the plurality of analysts;
revising the preferred company valuation based on the revised company valuations from the plurality of analysis to obtain a final company valuation; and
compensating the plurality of analysts based on at least one of the proximity of initial company valuation to preferred company valuation and the proximity of revised company valuation to final company valuation.

2. The method of claim 1 wherein a market maker is present during the substantially real time communication and a specific one of the revised company valuations is communicated to the market maker and to the one of the plurality of analysts who provided the specific one of the company valuations and is not communicated to the plurality of analysts who did not provide the specific one of the revised market valuations whereby the market maker is communicated all of the revised company valuations.

3. The method of claim 1 further comprising:
providing the preferred company valuation to each of the plurality of analysts prior to establishing the real time communication between the plurality of analysts;
receiving from the plurality of analysts hedge options based on the initial company valuation of the plurality of analysts.

4. The method of claim 3 wherein the hedge options are at least one of rich options, lean options and fair options.

5. The method of claim 1 further comprising:
providing the preferred company valuation to a third party prior to establishing the substantially real time communication between the plurality of analysts;
providing all of the initial company valuations by the plurality of analysts to the third party prior to establishing the substantially real time communication between the plurality of analysts; and
receiving from the third party options based on the initial company valuations of the plurality of analysts.

6. The method of claim 5 wherein the hedge options are at least one of rich options, lean options and fair options.

7. A method for substantially real time company valuation by a plurality of analysts comprising:
providing company information to the plurality of analysts;
receiving an initial company valuation from each of the plurality of analysts;
deriving a preferred company valuation based on the initial company valuation from each of the plurality of analysts;
providing the initial company valuation from each of the plurality of analysts to all of the plurality of analysts;
establishing substantially real time communication between the plurality of analysts for analysis by the plurality of analysts of each of the initial company valuations;
receiving a revised company valuation from each of the plurality of analysts based on the substantially real time communication between the plurality of analysts; and
revising the preferred company valuation based on the revised company valuations from the plurality of analysts to obtain a final company valuation, wherein a market maker is present during the substantially real time communication and a specific one of the revised company valuations is communicated to the market maker and to the one of the plurality of analysts who provided the specific one of the company valuations and is not communicated to the plurality of analysts who did not provide the specific one of the revised market valuations whereby the market maker is communicated all of the revised company valuations.

8. The method of claim 7 further comprising:
providing the preferred company valuation to each of the plurality of analysts prior to establishing the real time communication between the plurality of analysts;
receiving from the plurality of analysts hedge options based on the initial company valuation of the plurality of analysts.

9. The method of claim 8 wherein the hedge options are at least one of rich options, lean options and fair options.

10. The method of claim 7 further comprising:
providing the preferred company valuation to a third party prior to establishing the substantially real time communication between the plurality of analysts;
providing all of the initial company valuations by the plurality of analysts to the third party prior to establishing the substantially real time communication between the plurality of analysts; and
receiving from the third party options based on the initial company valuations of the plurality of analysts.

11. The method of claim 10 wherein the hedge options are at least one of rich options, lean options and fair options.

12. A method for substantially real time company valuation by a plurality of analysts comprising:
providing company information to the plurality of analysts;
receiving an initial company valuation from each of the plurality of analysts;
deriving a preferred company valuation based on the initial company valuation from each of the plurality of analysts;
providing the initial company valuation from each of the plurality of analysts to all of the plurality of analysts;
establishing substantially real time communication between the plurality of analysts for analysis by the plurality of analysts of each of the initial company valuations;
receiving a revised company valuation from each of the plurality of analysts based on the substantially real time communication between the plurality of analysts;
revising the preferred company valuation based on the revised company valuations from the plurality of analysts to obtain a final company valuation;
providing the preferred company valuation to at least one of the plurality of analysts and a third party prior to establishing the substantially real time communication between the plurality of analysts;
providing all of the initial company valuations by the plurality of analysts to the third party prior to establishing the substantially real time communication between the plurality of analysts; and
receiving from at least one of the third party and the plurality of analysts options based on the initial company valuations of the plurality of analysts.

13. The method of claim 12 wherein a market maker is present during the substantially real time communication and a specific one of the revised company valuations is communicated to the market maker and to the one of the plurality of analysts who provided the specific one of the company valuations and is not communicated to the plurality of analysts who did not provide the specific one of the revised market valuations whereby the market maker is communicated all of the revised company valuations.

14. The method of claim 12 wherein the hedge options are at least one of rich options, lean options and fair options.

15. A system for substantially real time company valuation by a plurality of analysts comprising:
a component for providing company information to the plurality of analysts;
a component for receiving an initial company valuation from each of the plurality of analysts;
a component for deriving a preferred company valuation based on the initial company valuation from each of the plurality of analysts;
a component for providing the initial company valuation from each of the plurality of analysts to all of the plurality of analysts;
a component for establishing substantially real time communication between the plurality of analysts for analysis by the plurality of analysts of each of the initial company valuations;
a component for receiving a revised company valuation from each of the plurality of analysts based on the substantially real time communication between the plurality of analysts;
a component for revising the preferred company valuation based on the revised company valuation from the plurality of analysts to obtain a final company valuation; and
a component for compensating the plurality of analysts based on at least one of the proximity of initial company valuation to preferred company valuation and the proximity of revised company valuation to final company valuation.

16. The system of claim 15 wherein a market maker is present during the substantially real time communication and a specific one of the revised company valuations is communicated to the market maker and to the one of the plurality of analysts who provided the specific one of the company valuations and is not communicated to the plurality of analysts who did not provide the specific one of the revised market valuations whereby the market maker is communicated all of the revised company valuations.

17. The system of claim 15 further comprising:
a component for providing the preferred company valuation to each of the plurality of analysts prior to establishing the real time communication between the plurality of analysts;
a component for receiving from the plurality of analysts hedge options based on the initial company valuation of the plurality of analysts.

18. The system of claim 17 wherein the hedge options are at least one of rich options, lean options and fair options.

19. The system of claim 15 further comprising:
a component for providing the preferred company valuation to a third party prior to establishing the substantially real time communication between the plurality of analysts;
a component for providing all of the initial company valuations by the plurality of analysts to the third party prior to establishing the substantially real time communication between the plurality of analysts; and
a component for receiving from the third party options based on the initial company valuations of the plurality of analysts.

20. The system of claim 19 wherein the hedge options are at least one of rich options, lean options and fair options.

21. A system for substantially real time company valuation by a plurality of analysts comprising:
a component for providing company information to the plurality of analysts;
a component for receiving an initial company valuation from each of the plurality of analysts;
a component for deriving a preferred company valuation based on the initial company valuation from each of the plurality of analysts;
a component for providing the initial company valuation from each of the plurality of analysts to all of the plurality of analysts;
a component for establishing substantially real time communication between the plurality of analysts for analysis by the plurality of analysts of each of the initial company valuations;
a component for receiving a revised company valuation from each of the plurality of analysts based on the substantially real time communication between the plurality of analysts; and
a component for revising the preferred company valuation based on the revised company valuations from the plurality of analysts to obtain a final company valuation, wherein a market maker is present during the substantially real time communication and a specific one of the revised company valuations is communicated to the market maker and to the one of the plurality of analysts who provided the specific one of the company valuations and is not communicated to the plurality of analysts who did not provide the specific one of the revised market valuations whereby the market maker is communicated all of the revised company valuations.

22. The system of claim 21 further comprising:
a component for providing the preferred company valuation to each of the plurality of analysts prior to establishing the real time communication between the plurality of analysts;
a component for receiving from the plurality of analysts hedge options based on the initial company valuation of the plurality of analysts.

23. The system of claim 22 wherein the hedge options are at least one of rich options, lean options and fair options.

24. The system of claim 21 further comprising:
a component for providing the preferred company valuation to a third party prior to establishing the substantially real time communication between the plurality of analysts;
a component for providing all of the initial company valuations by the plurality of analysts to the third party prior to establishing the substantially real time communication between the plurality of analysts; and
a component for receiving from the third party options based on the initial company valuations of the plurality of analysts.

25. The system of claim 24 wherein the hedge options are at least one of rich options, lean options and fair options.

26. A system for substantially real time company valuation by a plurality of analysts comprising:
a component for providing company information to the plurality of analysts;
a component for receiving an initial company valuation from each of the plurality of analysts;
a component for deriving a preferred company valuation based on the initial company valuation from each of the plurality of analysts;
a component for providing the initial company valuation from each of the plurality of analysts to all of the plurality of analysts;
a component for establishing substantially real time communication between the plurality of analysts for analysis by the plurality of analysts of each of the initial company valuations;
a component for receiving a revised company valuation from each of the plurality of analysts based on the substantially real time communication between the plurality of analysts;
a component for revising the preferred company valuation based on the revised company valuations from the plurality of analysts to obtain a final company valuation;
a component for providing the preferred company valuation to at least one of the plurality of analysts and a third party prior to establishing the substantially real time communication between the plurality of analysts;
a component for providing all of the initial company valuation by the plurality of analysts to the third party prior to establishing the substantially real time communication between the plurality of analysts; and
a component for receiving from at least one of the third party and the plurality of analysts hedge options based on the initial company valuations of the plurality of analysts.

27. The system of claim 26 wherein a market maker is present during the substantially real time communication and a specific one of the revised company valuations is communicated to the market maker and to the one of the plurality of analysts who provided the specific one of the company valuations and is not communicated to the plurality of analysts who did not provide the specific one of the revised market valuations whereby the market maker is communicated all of the revised company valuations.

28. The system of claim 26 wherein the hedge options are at least one of rich options, lean options and fair options.

29. A method for substantially real time company valuation by a plurality of analysts comprising:
providing company information to the plurality of analysts;
receiving an initial company valuation from each of the plurality of analysts;
deriving a preferred company valuation based on the initial company valuation from each of the plurality of analysts;
providing the initial company valuation from each of the plurality of analysts to all of the plurality of analysts;
establishing substantially real time communication between the plurality of analysts for analysis by the plurality of analysts of each of the initial company valuations;
receiving a revised company valuation from each of the plurality of analysts based on the substantially real time communication between the plurality of analysts; and
revising the preferred company valuation based on the revised company valuations from the plurality of analysis to obtain a final company valuation.

30. The method of claim 29 wherein a market maker is present during the substantially real time communication and a specific one of the revised company valuations is communicated to the market maker and to the one of the plurality of analysts who provided the specific one of the company valuations and is not communicated to the plurality of analysts who did not provide the specific one of the revised market valuations whereby the market maker is communicated all of the revised company valuations.

31. The method of claim 29 further comprising:
providing the preferred company valuation to each of the plurality of analysts prior to establishing the real time communication between the plurality of analysts;
receiving from the plurality of analysts hedge options based on the initial company valuation of the plurality of analysts.

32. The method of claim 31 wherein the hedge options are at least one of rich options, lean options and fair options.

33. The method of claim 29 further comprising:
providing the preferred company valuation to a third party prior to establishing the substantially real time communication between the plurality of analysts;
providing all of the initial company valuations by the plurality of analysts to the third party prior to establishing the substantially real time communication between the plurality of analysts; and
receiving from the third party options based on the initial company valuations of the plurality of analysts.

34. The method of claim 33 wherein the hedge options are at least one of rich options, lean options and fair options.

35. A system for substantially real time company valuation by a plurality of analysts comprising:
a component for providing company information to the plurality of analysts;
a component for receiving an initial company valuation from each of the plurality of analysts;
a component for deriving a preferred company valuation based on the initial company valuation from each of the plurality of analysts;
a component for providing the initial company valuation from each of the plurality of analysts to all of the plurality of analysts;
a component for establishing substantially real time communication between the plurality of analysts for analysis by the plurality of analysts of each of the initial company valuations;
a component for receiving a revised company valuation from each of the plurality of analysts based on the substantially real time communication between the plurality of analysts; and
a component for revising the preferred company valuation based on the revised company valuation from the plurality of analysts to obtain a final company valuation.

36. The system of claim 35 wherein a market maker is present during the substantially real time communication and a specific one of the revised company valuations is communicated to the market maker and to the one of the plurality of analysts who provided the specific one of the company valuations and is not communicated to the plurality of analysts who did not provide the specific one of the revised market valuations whereby the market maker is communicated all of the revised company valuations.

37. The system of claim 35 further comprising:
a component for providing the preferred company valuation to each of the plurality of analysts prior to establishing the real time communication between the plurality of analysts;
a component for receiving from the plurality of analysts hedge options based on the initial company valuation of the plurality of analysts.

38. The system of claim 37 wherein the hedge options are at least one of rich options, lean options and fair options.

39. The system of claim 35 further comprising:
a component for providing the preferred company valuation to a third party prior to establishing the substantially real time communication between the plurality of analysts;
a component for providing all of the initial company valuations by the plurality of analysts to the third party prior to establishing the substantially real time communication between the plurality of analysts; and
a component for receiving from the third party options based on the initial company valuations of the plurality of analysts.

40. The system of claim 39 wherein the hedge options are at least one of rich options, lean options and fair options.
